(19) United States
(12) Patent Application Publication
(10) Pub. No.: US 2003/0117904 A1
(43) Pub. Date: Jun. 26, 2003

(54) Remote LCD enforcement flag for parking meters

(76) Inventors: Ronald V. Lank, New Glasgow (CA); Darren S. Cameron, Stellarton (CA)

Correspondence Address: HAYES SOLOWAY PC, 130 W. Cushing Street, Tucson, AZ, 85701, US

(21) Appl. No.: 10/298,906

(22) Filed: Nov. 18, 2002

Related U.S. Application Data
(60) Provisional application No. 60/331,648, filed on Nov. 20, 2001.
(60) Provisional application No. 60/332,008, filed on Nov. 23, 2001.

(51) Int. Cl. G04F 1/00; G04F 3/00

(52) U.S. Cl. 368/90

(57) ABSTRACT

An enforcement shutter for an electronic meter comprises an enforcement display element having a highly visible surface and adapted to be fixed to the meter housing, and a cable for coupling the enforcement display element to the computer processor for controlling the operation of the enforcement display element. The enforcement shutter includes a holder having a window, a transparent protective plate positioned on the inner surface of the holder, a back plate adapted to be fixed to the holder for mounting the holder to the meter housing. The enforcement display element, which is positioned to face the transparent plate with a display surface visible in the holder window, may be mounted in the holder or to a surface of the inner electronic meter. The enforcement display element may be a LCD. When activated by the electronic meter processor to indicate that parking time has expired, the LCD displays a substantially uniform color and may be made to flash. In a further embodiment, a LCD display for an electronic parking meter comprises a display surface adapted to be positioned so as to be visible to a user. One or more display characters having a number of character segments are positioned on the display surface. The segments are adapted to be coupled to the computer processor for displaying parking time. At least one filler segment is positioned to cover essentially the entire visible display surface not used by the display characters. The filler segment is adapted to be coupled to the computer processor for indicating that the parking time has expired.

This application claims the benefit of U.S. Provisional Patent Application Serial No. 60/331,648 filed on Nov. 20, 2001 and U.S. Provisional Patent Application Serial No. 60/332,008 filed on Nov. 23, 2001.

### FIELD OF THE INVENTION

The invention relates generally to parking meters and more particularly to enforcement flags for parking meters.

### BACKGROUND OF THE INVENTION

Most electronic parking meters have a Liquid Crystal Display (LCD) at the front of the meter facing the user, who is facing the street. The LCD, which faces the user, is used to display the purchased time and or the time remaining on the meter to the users of the device. Traditionally, most electronic parking meters also have some form of enforcement display, flag, or indicator, which is visible at some distance to a user or a parking enforcement officer, to indicate that the purchased time has expired.

Older meters had mechanical enforcement flags, which were brightly painted red and highly visible at a distance from the meters. These mechanical flags were visible from either side of the meter. Some electronic meters have a further LCD fitted with a RED polarizer opposite to and at the back of the time LCD; the rear LCD is used to indicate when the meter has expired. This display is typically oriented such that it is facing to the curb or street for those enforcement staff that are patrolling the streets in an enforcement vehicle. When the meter is expired (no purchased time remaining) this rear display or enforcement flag can be made to alternately show a solid red display followed by a clear display, and then back to a solid red display. This flashing red/clear signal is easier to observe than a solid static display. The rear display remains static and clear when a user purchases time. The front or user display of most electronic parking meters has been augmented with light emitting diode (LED) indicators to provided additional indication to the enforcement staff that a meter has expired. These LED indicators are usually small, and difficult to see in bright sunlight. Both the front time LCD and the rear flag LCD are somewhat difficult to read through the round LEXAN domes found on most parking meters unless a person is close to the meter. Therefore, these LCDs do not provide the same degree of enforcement visibility as the older, brightly painted mechanical “flags”.

In addition some cities set the meters back on the sidewalk next to buildings instead of at the curb. This allows for unobstructed snow removal and garbage collection; however in this situation the time LCD is facing the street and the rear RED flag is no longer visible as that display now faces the building. The enforcement staff must rely solely on the indicators and display on the front to determine if the meter is expired.

Therefore there is a need for a more visible and effective enforcement display/flag/indicator for electronic parking meters.

### SUMMARY OF THE INVENTION

The invention is directed to an enforcement shutter for an electronic parking meter. The meter housing contains an electronic meter having a computer processor for controlling an unexpired time display in response to the payment for parking time, wherein the parking time display is visible to the user. The enforcement shutter comprises an enforcement display element adapted to be fixed to the meter housing and having a highly visible surface, a cable for connecting the enforcement display element to the computer processor for controlling the operation of the enforcement display element and a transparent plate for protecting the visible surface of the enforcement display element.

The enforcement display element may be a LCD, which when activated displays a substantially uniform color. The LCD may be activated to flash under the control of the meter processor when the paid parking time has expired.

In accordance with another aspect of the invention, the enforcement shutter, which is adapted to be mounted on the parking meter housing comprises an enforcement shutter holder having a window, a transparent protective plate positioned at the inner surface of the holder, a back plate adapted to be fixed to the holder for mounting the holder to the meter housing and an enforcement display element positioned to face the transparent plate with a display surface visible in the holder window.

The enforcement display element may be a LCD with a cable for connecting the enforcement display element to a computer processor within the electronic meter for controlling the operation of the enforcement display element when the paid parking time has expired. When activated, the LCD displays a substantially uniform color and may be made to flash.

In accordance with a specific aspect of the invention, the holder outside surface is bevelled and the holder inside surface is recessed to receive the transparent protective plate. The back plate is adapted to fix the holder and the transparent plate within an opening in the meter housing, whereas the enforcement display element is fixed to the electronic meter.

In accordance with another specific aspect of the invention the holder inside surface is recessed to receive the transparent protective plate and the enforcement display element and the back plate fixes the transparent plate and the enforcement display element within an opening in the meter housing.

In accordance with a further aspect of the invention, a LCD display for an electronic parking meter having a computer processor comprises a display surface adapted to be positioned so as to be visible to a user. One or more display characters having a number of character segments are positioned on the display surface. The segments are adapted to be coupled to the computer processor for displaying parking time. At least one filler segment is positioned to cover essentially the entire visible display surface not used by the display characters. The filler segment is adapted to be coupled to the computer processor for indicating that the parking time has expired.

The LCD may include a red polarizer. The LCD display may include six display characters where four display characters each include seven segments and the remaining display characters include one segment.

In accordance with another aspect of this invention, an electronic parking meter comprises a LCD display visible to a user, a computer processor for controlling the LCD display. The LCD display comprises a display surface, one or more display characters on the display surface having a number of character segments adapted to be coupled to the computer processor for displaying parking time, and at least one filler segment covering essentially the entire display surface not used by the display characters. The filler segment is adapted to be coupled to the computer processor for indicating that the parking time has expired.

The computer processor may control the segments of the display characters and the filler segment to be activated simultaneously for indicating that the parking time has expired.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 illustrates an electronic meter housing;

FIG. 2 illustrates an electronic meter interior structure;

FIG. 3 illustrates an enforcement LCD shutter in accordance with the present invention;

FIGS. 4 and 5 illustrate the back and side views of the holder;

FIG. 6 illustrates in exploded view one embodiment of the enforcement LCD shutter;

FIG. 7 illustrates the back plate for the FIG. 6 enforcement LCD shutter;

FIG. 8 illustrates in exploded view a second embodiment of the enforcement LCD shutter;

FIG. 9 illustrates the back plate for the FIG. 8 enforcement LCD shutter; and

FIGS. 10a and 10b schematically illustrate an LCD in accordance with the present invention.

### DETAILED DESCRIPTION OF THE INVENTION

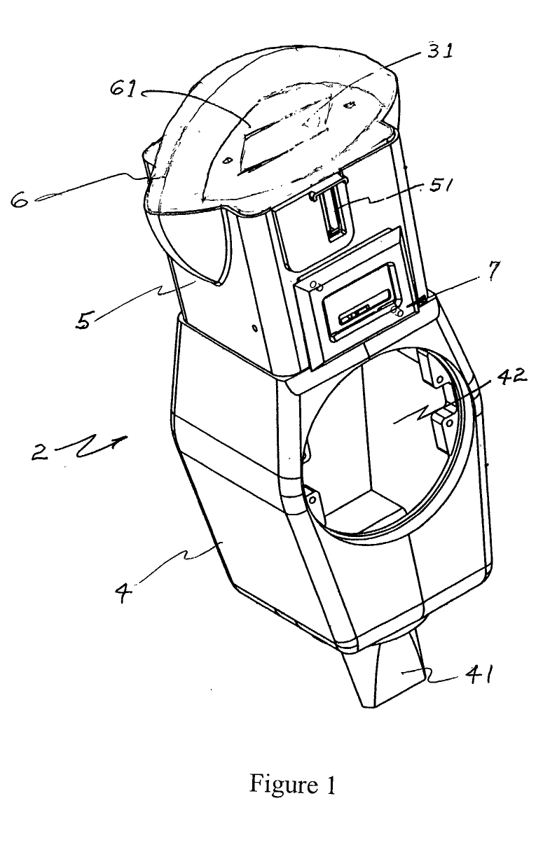

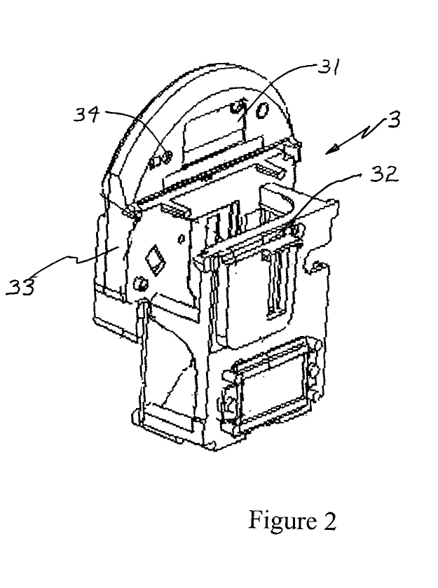

Conventional electronic meters include two basic components as illustrated in FIGS. 1 and 2. The meter comprises a housing 2 illustrated in FIG. 1 and the electronic meter interior structure 3 illustrated in FIG. 2. The housing 2 includes a lower housing 4, an upper housing 5 and a meter cap 6. The lower housing 4 is adapted to be attached to a pedestal using the pillar 41 and includes a coin storage box (not shown), which locks into opening 42. The upper housing 5 includes a payment slot 51 and receives the electronic meter interior structure 3. The cap 6, which is hinged and locks to the upper housing 5, includes a transparent dome 61, made of LEXAN™ or some similar type of highly durable material, through which the time display 31 is visible. As illustrated in FIG. 2, the interior structure 3 includes a time display 31, a coin and/or card detector 32 as well as a processor 33 for operating the meter. The electronic meter may also include a LED 34 to indicate that the purchased time has expired. In FIG. 1, a remote enforcement shutter 7 is shown positioned at the front of the upper housing 5.

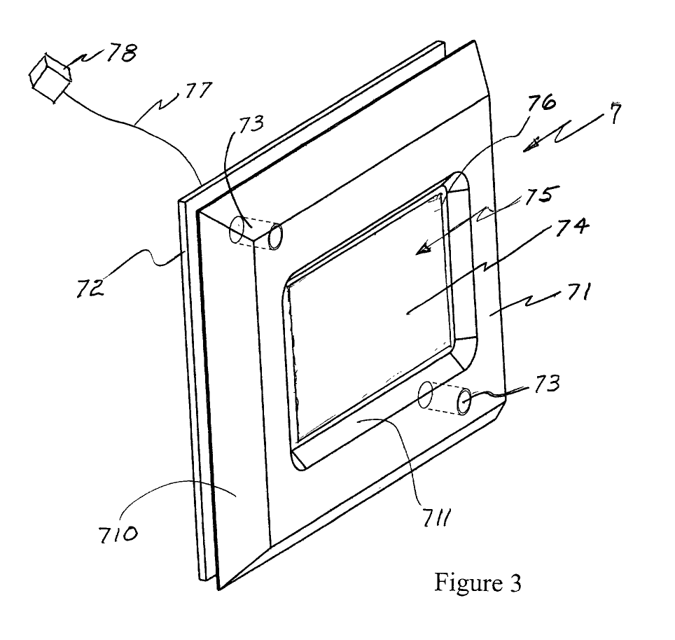

In accordance with the present invention, an LCD is positioned on the meter housing 2 in such a manner that it is remote from the time display 31, as well as highly visible even at a distance from the meter. As schematically illustrated in FIG. 3, the remote enforcement LCD shutter 7 includes a bezelled holder 71 and a back plate 72 that are adapted to be attached to one another such as by bolts or screws 73. The holder 71 includes a window 74 a transparent plate 75, followed by an LCD 76, which is visible from the front of the shutter 7 when the transparent plate 75 and the LCD are positioned within a recess at the back of the frame 71. One end of a small interface cable 77 is connected to the LCD 76, while the other end has a connector 78 adapted to be coupled to the processor 33.

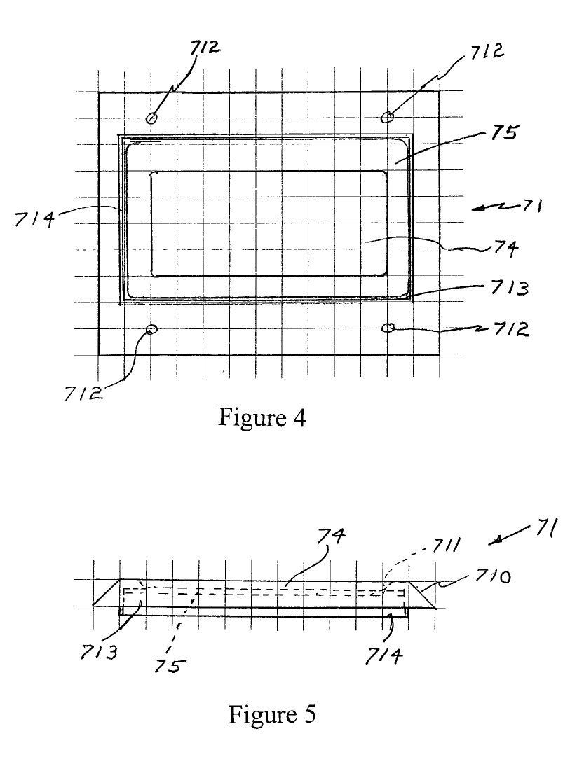

A more detailed back view and top view of the holder 71 are shown in FIGS. 4 and 5, and will be described in conjunction with FIG. 3. The front outside edges 710 and edges 711 of window 74 are bevelled to discourage anyone from trying to grip the holder 71 to remove it. As seen from the back, the holder 71 includes threaded holes 712 for receiving mounting screws 73. In addition, the holder 71 includes a recess 713, which is larger then the window 74. The outside edges of the recess 713 protrude out from the holder 71 to form a lip 714 along the four sides of the recess 713. The depth of the lip 714 is made slightly smaller then the thickness of the wall on which the holder 71 is to be mounted. As shown schematically in FIG. 5, the transparent plate 75 is positioned within the recess 713 covering substantially the entire area of the recess 713. An LCD (not shown) in FIG. 5 is adapted to be positioned immediately behind the transparent plate 75.

The enforcement LCD shutter 7 may be fixed to any outside wall of the housing 2, however, it is preferred to install the enforcement LCD shutter 7 within an opening in the housing 2 wall such that it is held in place by the backing plate 72 as will be described below. The enforcement LCD shutter 7 as generally described above is particularly advantageous since the LCD 76 is located in close proximity to the transparent plate 75 to minimize reflections and maximize visibility.

The remote enforcement LCD shutter 7 is best located in a position that provides the greatest visibility to a user and/or an enforcement officer. For meters that are located close to buildings, it would be preferred to position the enforcement LCD shutter 7 at the front of the meter either on the upper 5 or lower 4 housing. In other situations, it may be preferable to have the enforcement LCD shutter 7 on a side or the back of the meter. Alternately two or more enforcement LCD shutters 7 may be placed on different sides of the meter. However, for simplicity of installation and for practicality with regard to most applications, the enforcement LCD shutter 7 is located in an opening at the front of the upper housing 5 as shown in FIG. 1.

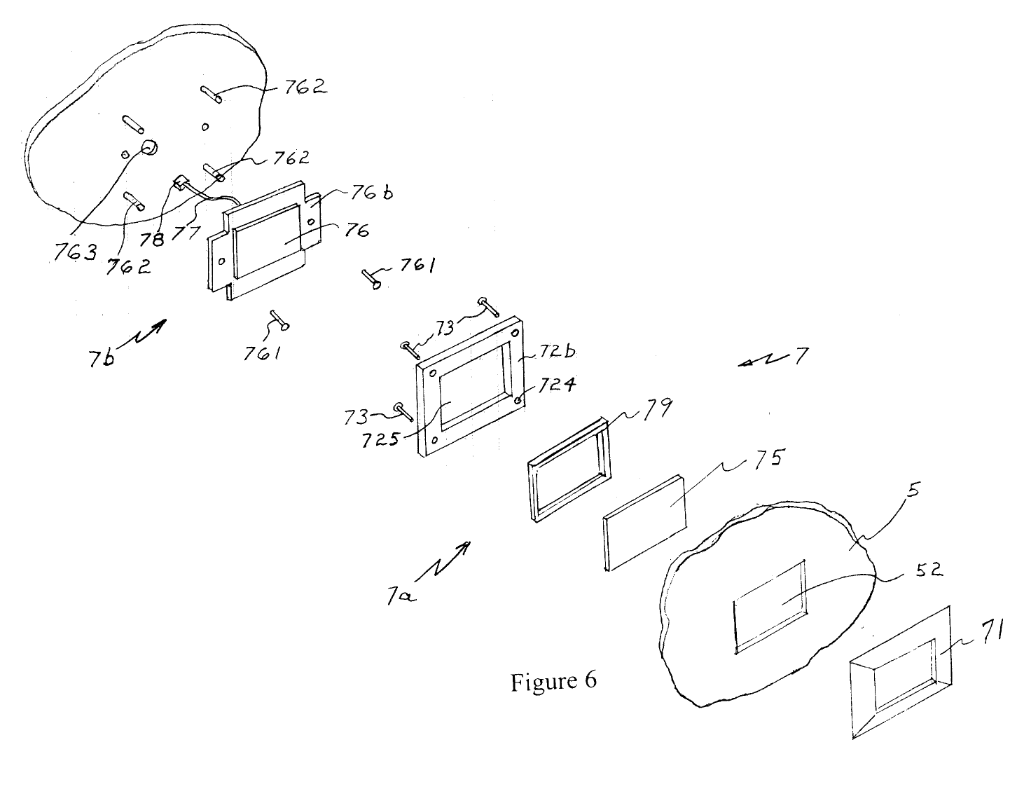

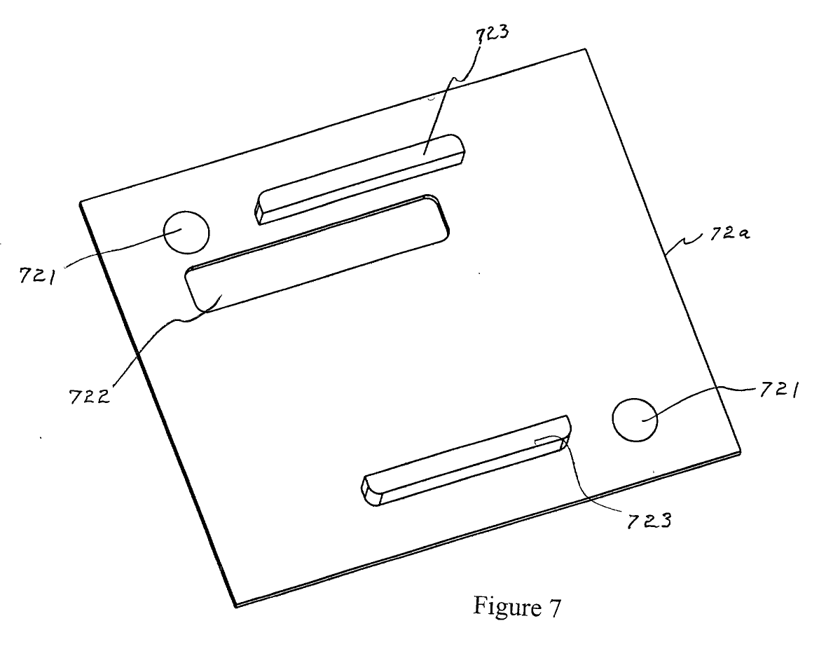

In the embodiment of the enforcement LCD shutter 7 shown in FIG. 6 in exploded view, the entire enforcement LCD shutter 7 including the LCD 76 is adapted to be fixed to the wall of the housing 4 or 5. The enforcement LCD shutter 7 includes the bezelled holder 71 that fits snugly within an opening 52 in the wall of housing 5, for example. An u.v. LEXAN transparent plate 75 followed by a gasket 79 is placed within the recess 713 of holder 71. The LCD 76, which is normally mounted on a circuit board 76a, is then placed within the recess 713. A back plate 72a of the type illustrated in FIG. 7 is positioned over the back of the circuit board 76a mounted LCD 76. The dimensions of the back plate 72a, in length and width, are similar to those of the holder 71, in that the back plate also overlaps the sides of the opening 52 in housing 5. The back plate includes holes 721 through which screws or bolts 73 are screwed into the holder 71 to hold all of the components of the shutter 7 together and to fix the enforcement LCD shutter 7 to the housing 5 wall. The plate 72a also includes an opening 722 through which the cable 77 is passed for connection to the meter processor 33. The back plate 72a may also include two protrusions 723 which butt up against the LCD 76 circuit board 76a to assure that the components of the enforcement LCD shutter 7 fit tightly against one another and that the LCD 76 is close to the transparent plate 75.

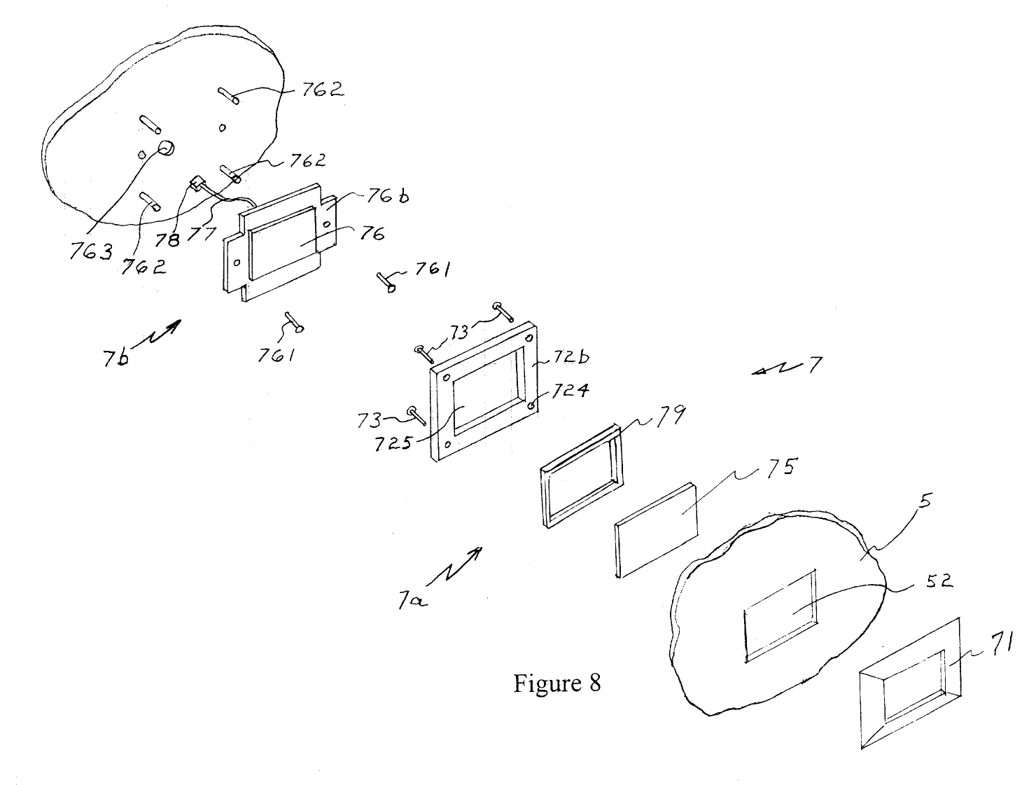

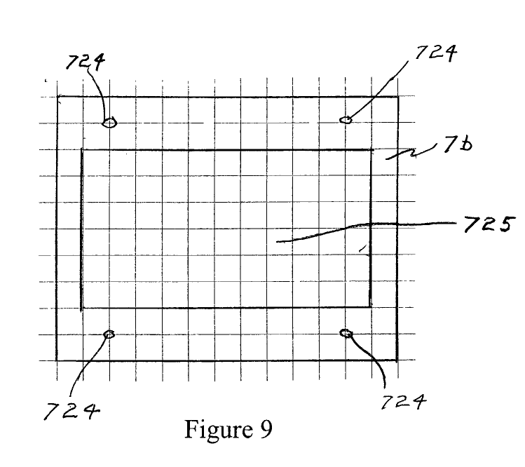

In a further embodiment of the enforcement LCD shutter 7 shown in FIG. 8 in exploded view, the housing 7a for the enforcement LCD shutter 7 is adapted to be fixed to the wall of the housing 4 or 5, while the LCD 76 arrangement 7b is fixed to a wall of the electronic meter interior structure 3. In this embodiment, the enforcement LCD shutter 7 housing 7a includes the bezelled holder 71 that fits snugly within an opening 52 in the wall of housing 5, for example. An u.v. LEXAN transparent plate 75 followed by a gasket 79 is placed within the recess 713 of holder 71. A back plate 72b of the type illustrated in FIG. 9, with dimensions similar in length and width to those of the holder 71, overlaps the sides of the opening 52 in housing 5. The backplate 7b includes holes 724 through which screws or bolts 73 are screwed into the holder 71 to hold it tightly against the housing 5 wall. The back plate 7b includes an opening 725 which will allow circuit board 76b mounted LCD 76 to penetrate the recess 713 of the holder 71. In this embodiment, the circuit board 76b is fixed to the wall of the meter interior structure 3 by screws or bolts 761. Further spacing posts 762 may be fixed in the wall of the meter interior structure 3, the posts 762 would be slightly longer then the thickness of the LCD 76 with its circuit board 76b to protect the LCD 76 when the interior structure 3 is slipped into the upper housing 5 such that the LCD 76 enters into the recess 713 of holder 71. The wall of the interior structure 3 may also include an opening 763 for the LCD cable 77.

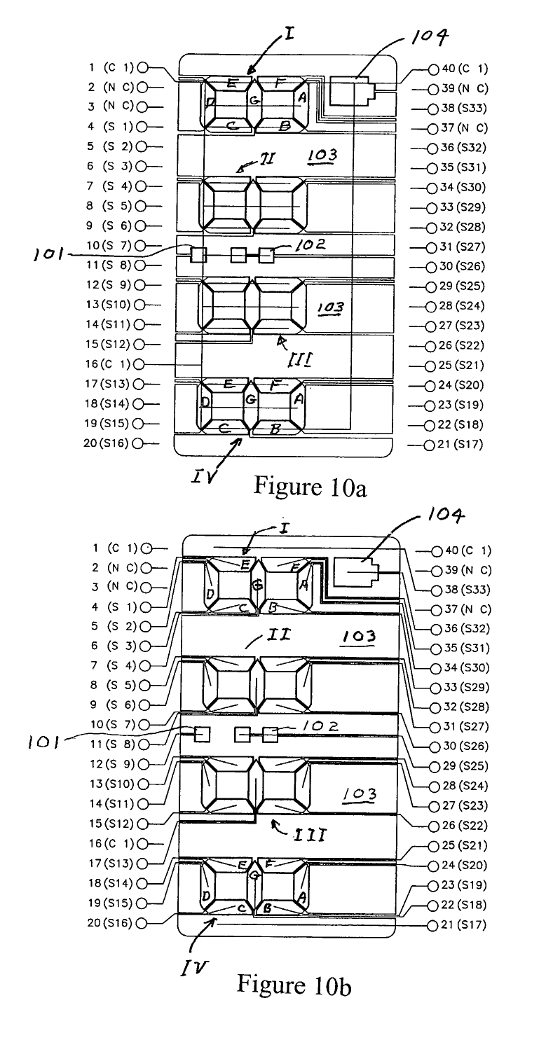

In the embodiments of the enforcement LCD shutter 7 described above, the LCD 76 itself includes a red polarizer, which is controlled to provide either a clear display or a solid red display to indicate that time has not expired or has expired, respectively. The time LCD 31, on the other hand as illustrated in FIG. 10a, generally includes four display characters I, II, III, and IV each made up of seven segments that are individually controlled through lines from pins on the LCD. For example in FIG. 10a, the segments a, b, c, d, e and f for each of the display characters I, II, III, and IV are connected to pin numbers 4 to 11, 13 to 15, 17 to 20, 22 to 28 30 to 35. LCD 31 in FIG. 10a also includes a decimal place segment 101 and a colon segment 102 which are connected to pins 12 and 29 respectively. Finally, as is illustrated, a battery symbol or icon 104 is connected to pin 36. As shown on FIG. 10b, the LCD back plane is connected to three pins 1, 16 and 40, which are spaced about the LCD 31 to achieve maximum polarization with reduced delay.

In a further embodiment of the present invention, the time display 31 has a duality in functionality in that it shows the user the purchased and or countdown time in a conventional manner by segmented characters I to IV, but in addition when the meter is in an expired state, the LCD display 31 emulates the enforcement LCD shutter 7, by appearing as a solid red shutter display. This duality in functionality is achieved by a non-traditional approach in the design of the time LCD whereby essentially all of the normally unused clear space surrounding the four display characters I to IV and the segments 101 and 102 is replaced with an active filler segment 103 that can be turned on/off in a similar fashion as any of the standard segments a to f in the four 7-segment characters I to IV. The filler segment 103 may include more then one segment, though they would be controlled as a unit. In FIG. 10a, the lines from pins 21 and 38, which are located at each end of the LCD 31 to maximize polarization, are used to control the filler segment 103. In this particular embodiment, the LCD is fitted with a red polarizer such that all of display segments I to IV, 101 and 102, and the filler segment 103 all appear red when activated. The above time display 31, when in the expired mode, can also be augmented by a much larger and brighter LED indicator 34 with improved characteristics, such as through the use of a diffused lens that allows it to be observed at a greater distance and wider viewing angle in bright sunlight.

In operation, the parking time is being displayed, under the control of the electronic parking meter 3, by the segments a to f of the characters I to IV, the decimal segment 101 and/or the colon segment 102. When the parking time expires, the meter 3 will turn on the active filler segment 103. To achieve a virtually solid red display, all or most of the character segments are also turned on. To gain attention, the solid red display may be turned on and off at some predetermined frequency. The LED may also be operated to blink at a predetermined rate that may be in the order of 12 Hz to further attract the attention of a user or an enforcement officer and also conserve energy.

The enforcement LCD shutter 7 described above is particularly advantageous since it provides a motorist and/or an enforcement officer a clear indication, from a distance, when a parking meter is expired. At the same time, the construction is sufficiently robust to prevent any attempts to break into the parking meter.

The embodiment of a dual function time display may be used alone or in conjunction with the remote enforcement LCD shutter 7 described above, and is particularly useful in areas of high vandalism where any external attachments or remote displays would be quickly removed and rendered ineffective.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. In an electronic parking meter with a housing for containing an electronic meter having a computer processor for controlling an unexpired time display in response to the payment for parking time, wherein the parking time display is visible to the user, an enforcement shutter comprising:
an enforcement display element adapted to be fixed to the meter housing and having a highly visible surface;
a cable for connection between the enforcement display element and the computer processor for controlling the operation of the enforcement display element; and
transparent means for protecting the visible surface of the enforcement display element.

2. An enforcement shutter as claimed in claim 1 wherein the enforcement display element is a LCD.

3. An enforcement shutter as claimed in claim 2 wherein the activated LCD displays a substantially uniform color.

4. An enforcement shutter as claimed in claim 3 wherein the LCD is activated under the control of the meter processor when the paid parking time has expired.

5. An enforcement shutter as claimed in claim 3 wherein the LCD is activated to flash under the control of the meter processor when the paid parking time has expired.

6. In an electronic parking meter with a housing for containing an electronic meter having a computer processor for controlling an unexpired time display in response to the payment for parking time, wherein the parking time display is visible to the user, an enforcement shutter for mounting on the parking meter housing comprising:
an enforcement shutter holder having a window, the holder having an inner surface and an outer surface;
a transparent protective plate positioned at the inner surface of the holder;
a back plate adapted to be fixed to the holder for mounting the holder to the meter housing; and
an enforcement display element positioned to face the transparent plate with a surface visible in the holder window.

7. An enforcement shutter as claimed in claim 6 wherein the enforcement display element is a LCD and includes a cable for connection between the LCD and the computer processor for controlling the operation of the LCD.

8. An enforcement shutter as claimed in claim 6 wherein the holder outside surface is bevelled.

9. An enforcement shutter as claimed in claim 6 wherein the holder inside surface is recessed to receive the transparent protective plate.

10. An enforcement shutter as claimed in claim 9 wherein the back plate fixes the holder and the transparent plate within an opening in the meter housing.

11. An enforcement shutter as claimed in claim 10 wherein the enforcement display element is fixed to the electronic meter.

12. An enforcement shutter as claimed in claim 10 wherein the opening in the meter housing is located on a wall adapted to face a parked vehicle.

13. An enforcement shutter as claimed in claim 6 wherein the holder inside surface is recessed to receive the transparent protective plate and the enforcement display element.

14. An enforcement shutter as claimed in claim 11 wherein the back plate fixes the transparent plate and the enforcement shutter within an opening in the meter housing.

15. An enforcement shutter as claimed in claim 11 wherein the opening in the meter housing is located on a wall adapted to face a parked vehicle.

16. An enforcement shutter for an electronic parking meter having a housing, comprising:
an enforcement shutter holder having a window, the holder having an inner surface and an outer surface;
a transparent protective plate positioned at the inner surface of the holder;
a back plate adapted to be fixed to the holder for mounting the holder to the meter housing; and
an enforcement display element positioned to face the transparent plate with a surface visible in the holder window.

17. An enforcement shutter as claimed in claim 16 wherein the holder outside surface is bevelled.

18. An enforcement shutter as claimed in claim 17 wherein the holder inside surface is recessed to receive the transparent protective plate and the enforcement display element.

19. An enforcement shutter as claimed in claim 18 wherein the back plate fixes transparent plate and the enforcement display element within an opening in the meter housing.

20. An enforcement shutter as claimed in claim 19 wherein the opening in the meter housing is located on a wall adapted to face a parked vehicle.

21. An enforcement shutter as claimed in claim 20 wherein the enforcement display element is a LCD.

22. An enforcement shutter as claimed in claim 21 wherein the LCD includes a cable for connection between the enforcement display element and a computer processor within the electronic meter for controlling the operation of the enforcement display element.

23. An enforcement shutter as claimed in claim 22 wherein the activated LCD displays a substantially uniform color.

24. An enforcement shutter as claimed in claim 22 wherein the LCD is activated under the control of the meter processor when the paid parking time has expired.

25. An enforcement shutter as claimed in claim 23 wherein is activated to flash under the control of the meter processor when the paid parking time has expired.

26. A LCD display for an electronic parking meter having a computer processor comprising:
a display surface adapted to be positioned so as to be visible to a user;
one or more display characters on the display surface having a number of character segments adapted to be coupled to the computer processor for displaying parking time; and
at least one filler segment covering essentially the entire visible display surface not used by the display characters adapted to be coupled to the computer processor for indicating that the parking time has expired.

27. A LCD display as claimed in claim 26 wherein the LCD includes a red polarizer.

28. A LCD display as claimed in claim 27 wherein the LCD comprises six display characters

29. A LCD display as claimed in claim 28 wherein four display characters each include seven segments and the remaining display characters include one segment.

30. An electronic parking meter comprising:
a LCD display visible to a user;
a computer processor for controlling the LCD display, wherein the LCD display comprises:
a display surface;
one or more display characters on the display surface having a number of character segments adapted to be coupled to the computer processor for displaying parking time; and
at least one filler segment covering essentially the entire display surface not used by the display characters adapted to be coupled to the computer processor for indicating that the parking time has expired.

31. An electronic parking meter as claimed in claim 30 wherein the computer processor includes means for controlling the segments of the one or more display characters and the filler segment to be activated simultaneously for indicating that the parking time has expired.

32. An electronic parking meter as claimed in claim 31 wherein the segment controlling mean is adapted to activate all of the segments at a predetermined frequency.

33. An electronic parking meter as claimed in claim 32 wherein the LCD includes a red polarizer.

34. An electronic parking meter as claimed in claim 33 wherein the LCD comprises six display characters.

35. An electronic parking meter as claimed in claim 34 wherein four display characters each include seven segments and the remaining display characters include one segment.
